(19) United States
(12) Patent Application Publication
(10) Pub. No.: US 2008/0189564 A1
(43) Pub. Date: Aug. 7, 2008

(54) METHOD FOR SUPPLYING POWER TO MEMORY CARD AND MEMORY CARD SYSTEM

(76) Inventors: Seon Taek Kim, Suwon-si (KR); Byung-Gook Kim, Gwonseon-gu (KR)

Correspondence Address: F. CHAU & ASSOCIATES, LLC, 130 WOODBURY ROAD, WOODBURY, NY, 11797, US

(21) Appl. No.: 11/970,364

(22) Filed: Jan. 7, 2008

(30) Foreign Application Priority Data
Feb. 1, 2007 (KR) 10-2007-0010460

(51) Int. Cl. G06F 12/00; G06F 1/26

(52) U.S. Cl. 713/300; 711/115; 711/E12.001

(57) ABSTRACT

A method for supplying power to a memory card in a memory card system includes detecting a completion time of a write operation of the memory card, generating a power off strobe signal, the power off strobe signal supplied to the memory card after a predetermined delay time passes from the detected complete time of the write operation, and cutting off power supplied to the memory card using the host after a predetermined power off delay time passes from the time when the power off strobe signal is generated.

### CROSS-REFERENCE TO RELATED PATENT APPLICATIONS

This application claims the benefit of Korean Patent Application No. 10-2007-0010460, filed on Feb. 1, 2007, in the Korean Intellectual Property Office, the disclosure of which is herein incorporated by reference in its entirety.

### BACKGROUND OF THE INVENTION

1. Field of the Invention

The present invention relates to a memory card system, and more particularly, to a method for supplying power to a memory card and a memory card system.

2. Description of Related Art

Memory cards such as MMCs (multimedia cards) using NAND flash memories are used with hosts, for example, computers, digital cameras, electronic telephones and MP3 players. Typically, the memory cards such as MMCs, compact flash cards, smart media cards (SMCs), or secure digital (SD) cards can be separated from the host. When connected to the host, the memory cards receive basic power for the operation from the host.

The host can request the memory card to perform a read or write operation. When the memory card completes the read or write operation, the basic voltage supplied to the memory card is cut to reduce current consumption by the memory card.

FIG. 1 is a timing diagram of the write operation and power supply of an MMC. Referring to FIG. 1, a memory card (not shown) transmits a response signal Res1 to a host (not shown) in response to a first write command CMD-1 transmitted from the host to the memory card. The host, in response to the response signal Res1, transmits a data block and CRC (cycle redundancy codes) through data pins DAT0 to DAT7 of the memory card.

The transmitted data block is completely stored in a page buffer of the memory card and written in units of pages to a memory cell array. The time needed in this regard is referred to as a program busy time.

The data level of a first input pin DAT0 of the memory card can maintain a first level state, for example, a low level state, during the program busy time. After the program busy time passes, the voltage level of the first input pin DAT0 is transitioned to a second level state, for example, a high level state.

The voltage state of the first input pin during the program busy time is referred to as a program busy signal Pbusy. The time when the program busy signal Pbusy is transitioned to the second level state can be a write operation complete time T1. The host can check the level state of the program busy signal Pbusy. When the host requests the memory card to perform the write operation, the first data pin DAT0 can be used to check whether the write request has been completed. When the write operation of the memory card is complete, the host can cut the voltage supplied to the memory card.

The complete time T1 or T1′ of the write command of the memory card may vary according to the type of the first write command CMD-1. When the write operation is completed by a stop command CMD-2, the time when a busy signal busy generated after the stop command CMD-2 is transitioned to the second level state is the completion time T1′ of the write operation.

The memory card can perform a background operation after the write operation is complete. The background operation orders a large data file dispersively written over the memory cell array before the next write operation or erase blocks of the memory cell array to be erased in advance in the memory card when the host does not access the memory card, for example, after the write operation is complete. The background operation improves the performance of the memory card with respect to the write request from the host. The background operation cannot be performed when the supply of the basic voltage from the host is cut off.

Since the host can cut off the power supplied to the memory card after the completion of the write operation, the memory card may lose an opportunity to perform the background operation after completing the operation requested by the host, for example, a write operation. Therefore, a method for supplying power to the memory card which can guarantee the background operation of the memory card is needed.

### SUMMARY OF THE INVENTION

According to an embodiment of the present invention, a method for supplying power to a memory card in a memory card system comprises detecting, by a host, a completion time of a write operation of the memory card, generating, by the host, a power off strobe signal, the power off strobe signal supplied to the memory card after a predetermined delay time passes from the complete time of the write operation, and cutting off power, by the host, supplied to the memory card after the predetermined power off delay time passes from the time when the power off strobe signal is generated.

The method further comprises receiving information about the predetermined power off delay time from the memory card when the host initializes the memory card.

The completion time of the write operation is detected based on a busy signal generated during the write operation.

The generating of the power off strobe signal comprises maintaining a voltage level of any one of a plurality of data pins at a first level before the predetermined delay time passes from the completion time of the write operation, and transitioning the voltage level of the data pin to a second level after the predetermined delay time passes.

According to another embodiment of the present invention, a method for supplying power to a memory card in a memory card system comprises detecting, by the memory card, a completion time of a write operation, and generating, by the memory card, a power off strobe signal to cut off power supply to the memory card after a predetermined power off delay time passes from completion time of the write operation.

The method further comprises storing the predetermined power off delay time, and providing, by the memory card, the stored predetermined power off delay time to a host when the memory card is initialized.

The method further comprises transmitting the generated power off strobe signal to the host, wherein the host in response to the power off strobe signal cuts off the power supply to the memory card.

The completion time of the write operation is detected based on a busy signal of the write operation.

According to another embodiment of the present invention, a computer readable medium embodying instructions executable by a processor to perform the method for supplying power to the memory card.

According to another embodiment of the present invention, a memory card system comprises a memory card storing data, and a host detecting a completion time of a write operation of the memory card and generating a power off strobe signal, the power off strobe signal supplied to the memory card after a predetermined delay time passes from the detected completion time of the write operation, wherein the host cuts off power supplied to the memory card after the predetermined power off delay time passes from the time when the power off strobe signal is generated in the memory card.

The host detects the completion time of the write operation based on a busy signal of the write operation.

According to another embodiment of the present invention, a memory card system comprises a memory card storing data, and a host cutting off power supplied to the memory card in response to a power off strobe signal, wherein the memory card detects a completion time of a write operation corresponding to a write request from the host and generates the power off strobe signal after a predetermined power off delay time passes from the detected completion time of the write operation.

The memory card detects the completion time of the write operation based on a busy signal of the write operation.

### BRIEF DESCRIPTION OF THE DRAWINGS

The present invention will become more apparent by describing in detail preferred embodiments thereof with reference to the attached drawings in which:

FIG. 1 is a timing diagram of the write operation and power supply of an MMC;

FIG. 2 is a block diagram of a memory card system according to an embodiment of the present invention;

FIG. 3 illustrates the pins included in the memory card of FIG. 2;

FIG. 4 illustrates descriptions of each of the pins shown in FIG. 3;

FIG. 5 is a flowchart for explaining a method for supplying power to a memory card according to an embodiment of the present invention;

FIG. 6 is a first timing diagram for explaining the power supply method of FIG. 5;

FIG. 7 is a second timing diagram for explaining the power supply method of FIG. 5;

FIG. 8 is a flowchart for explaining a method for supplying power to a memory card according to anther embodiment of the present invention;

FIG. 9 is a third timing diagram for explaining the power supply method of FIG. 8; and

FIG. 10 is a fourth timing diagram for explaining the power supply method of FIG. 8.

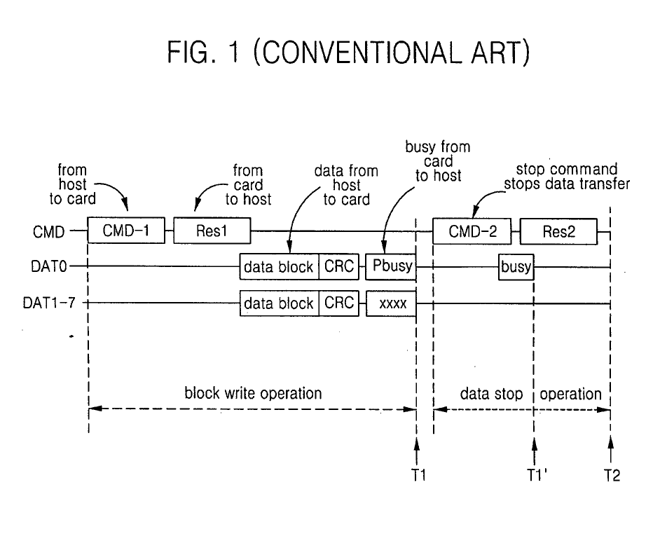

### DETAILED DESCRIPTION OF EXEMPLARY EMBODIMENTS

The attached drawings for illustrating exemplary embodiments of the present invention are referred to in order to gain a sufficient understanding of the present invention, the merits thereof. Hereinafter, the present invention will be described in detail by explaining exemplary embodiments of the invention with reference to the attached drawings. Like reference numerals in the drawings denote like elements.

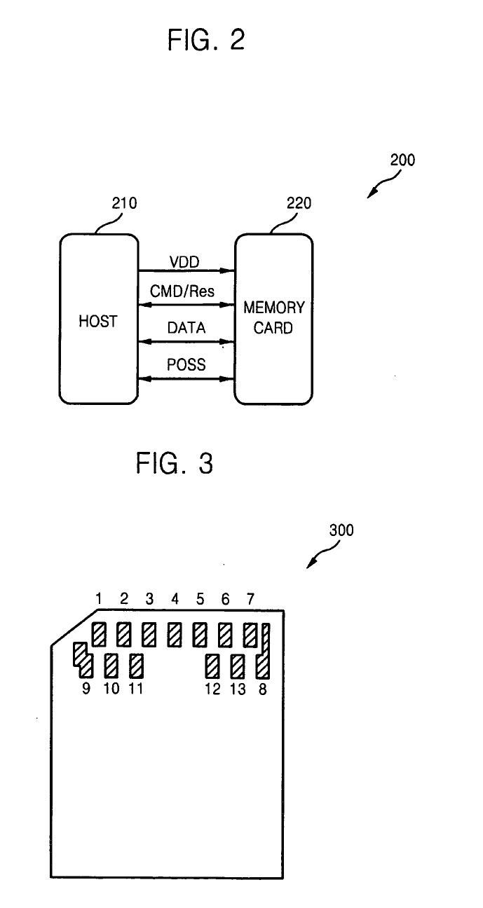

FIG. 2 is a block diagram of a memory card system according to an embodiment of the present invention. Referring to FIG. 2, a memory card system 200 includes a host 210 and a memory card 220. The host 210 includes a data storing portion (not shown) storing a program of instructions and a processor (not shown) for executing the instructions. The host 210 resets the memory card 220 and identifies the memory card 220. The host 210 transmits a command CMD and data DATA to the memory card 220. The memory card 220 transmits a response signal Res in response to the command CMD to the host 210 and data DATA to the host 210 during a read operation.

The program of instructions is executed for detecting the completion time of the write operation of the memory card 220 using the host 210, generating a power off strobe signal POSS to the memory card 220 using the host 210 after a predetermined delay time from the completion time of the detected write operation, and cutting off power VDD supplied to the memory card 220 using the host after the predetermined power off delay time PODT passes from the time when the POSS is generated.

The predetermined PODT is preset and stored in a register (not shown) included in the memory card 220. When the host 210 resets the memory card 220, the host 210 receives information about the predetermined PODT from the memory card 220, and the host 210 generates a POSS to the memory card 220. In receiving the POSS, the memory card 220 has a time to perform the background operation before the predetermined PODT passes from the generation of the POSS.

Unlike the above case, the memory card 220 can generate a POSS. The memory card 220 detects the completion time of the write operation corresponding to the write command CMD requested by the host 210 and generates a POSS after the predetermined PODT passes from the completion time of the detected write operation. The memory card 220 transmits the generated POSS to the host 210. In response to the transmitted POSS, the host 210 cuts off the VDD supplied to the memory card 220.

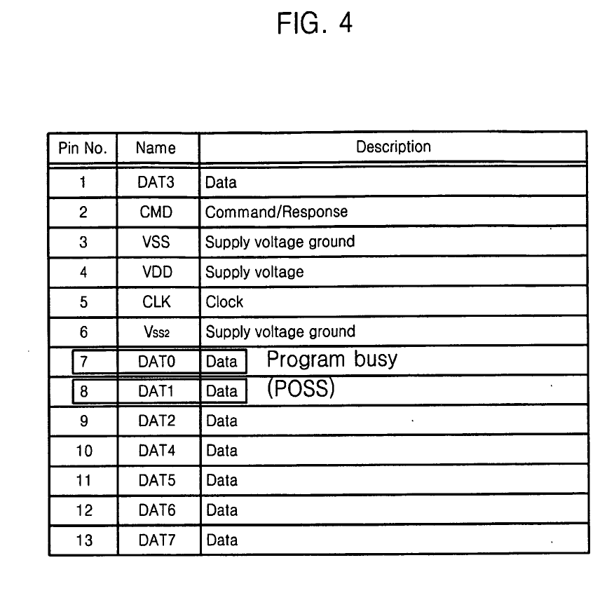

FIG. 3 illustrates pins 1 to 13 included in the memory card of FIG. 2. FIG. 4 illustrates descriptions of each of the pins 1 to 13 shown in FIG. 3. Referring to FIGS. 3 and 4, the first data pin DAT0, having a pin number of 7, indicates a program busy signal. The POSS can be transmitted and received between the host 210 and the memory card 220 through a second data pin, for example, DAT1, of the data pins DAT0, DAT1 to DAT7 shown in FIG. 3.

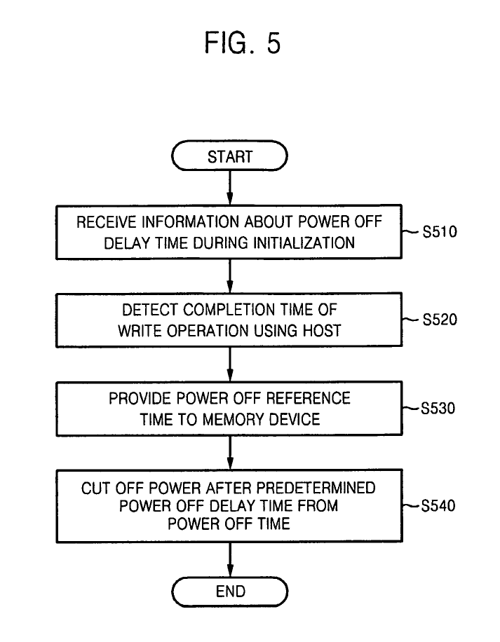

FIG. 5 is a flowchart for explaining a method for supplying power to a memory card according to an embodiment of the present invention. Referring to FIGS. 2 and 5, while the host 210 resets the memory card 220, the host 210 receives information about the predetermined PODT from the memory card 220 (S510).

The host 210 detects the completion time of the write operation of the memory card 220 corresponding to the write command transmitted to the memory card 220 (S520). The completion time of the write operation of the memory card 220 is determined based on a type of the write command.

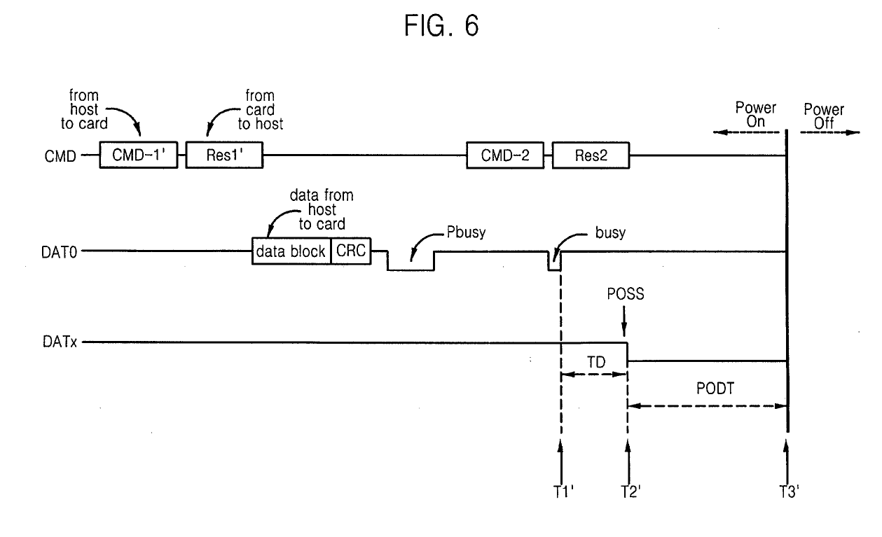

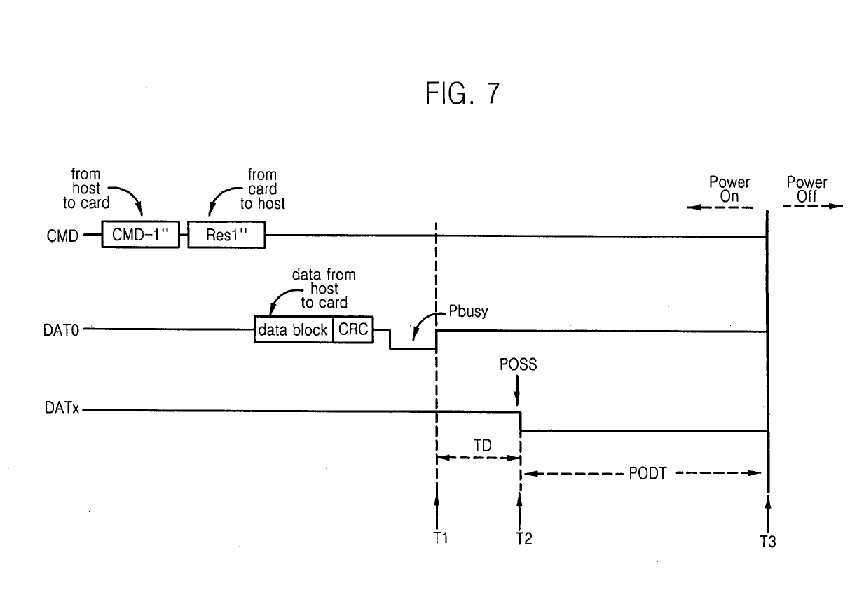

FIG. 6 is a first timing diagram for explaining the power supply method of FIG. 5. FIG. 7 is a second timing diagram for explaining the power supply method of FIG. 5. Referring to FIG. 6 and 7, it can be seen that the completion time T1 or T1′ of the write operation are different according to the type of the first write command CMD-1′ or a second write command CMD-1″ transmitted from the host 210 to the memory card 220.

FIG. 6 shows a case in which the write operation is completed by the stop command CMD-2. For example, the completion time of the write operation corresponding to the first write command CMD-1′ can be the time T1′ when the busy signal busy in the first level state, for example, a low level state, generated in the first data pin DAT0 is transitioned to the second level state, for example, a high level state, after the stop command CMD-2 is received from the host 210.

FIG. 7 shows a case in which the write operation is completed when the program busy state is complete. For example, the completion time of the write operation corresponding to a second write command CMD-1″ can be the time T1 when the program busy signal Pbusy in the first level state, for example, a low level state, is transitioned to the second level state, for example, a high level state.

The host 210 identifies whether the write operation has been completed by checking the program busy signal Pbusy of the first data pin DAT0 of the memory card 220. For example, the host 210 can detect the completion time of the write operation by checking the time T1 when the voltage level of the first data pin DAT0 is transitioned from the first level state, for example, a low level state, to the second level state.

The host 210 provides a power off reference time to the memory card 220 after the predetermined delay time TD passes from the detected completion time T1 or T1′ of the write operation (S530). The host 210 can use any one of the data pins of the memory card 220 to provide the memory card 220 an indication of the power off reference time. For example, the host 210 maintains the voltage level of any one of the data pins DATX, where x is a natural number, in the first level state, for example, a high level state, from the completion time T1 or T1′ of the write operation. The host 210 can transition the voltage level of the data pin, for example, DAT1, to the second level state, for example, a low level state, after the predetermined delay time passes from the completion time T1 or T1′ of the write operation.

The host 210 generates a signal that is transitioned from the first level to the second level in any one of the data pins, for example, DAT1, when the predetermined delay time TD passes from the completion time T1 or T1′ of the write operation. The signal transitioned from the first level to the second level is referred to as a power off strobe signal POSS.

As described above, the memory card 220 can recognize the power off reference time T2′ or T2 through the POSS generated in the data pin, for example, DAT1. The host 210 cuts off power to the memory card 220 at the time T3′ or T3 after the PODT passes from the time T2′ or T2 when the power off strobe signal is generated (S540). The host 210 cuts the VDD supplied to the memory card 220 after the predetermined PODT passes from the time T2′ or T2 when the POSS is generated in the memory card 220.

The memory card 220 can complete the background operation until the predetermined PODT passes from the time T2′ or T2 when the POSS is generated.

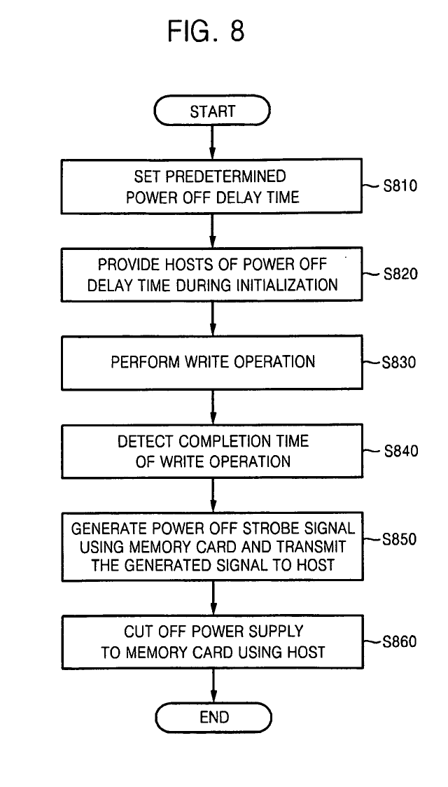

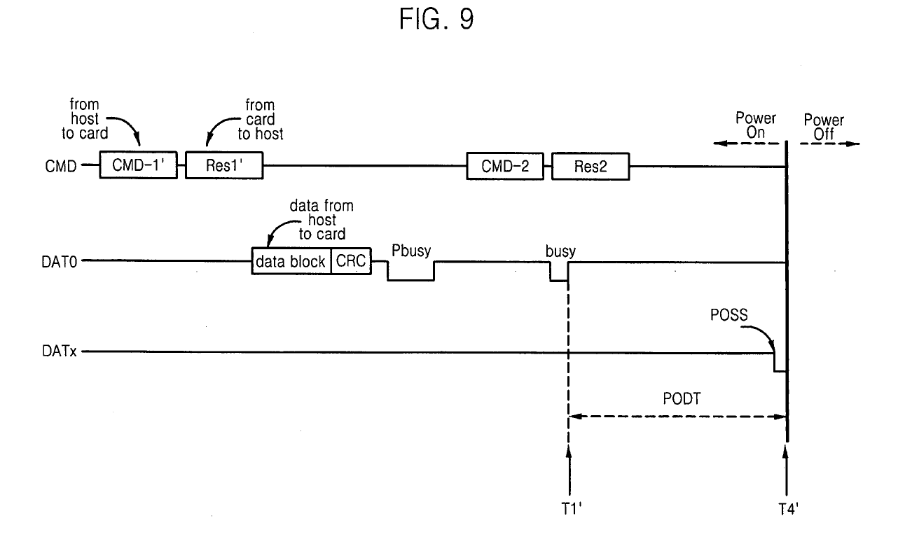

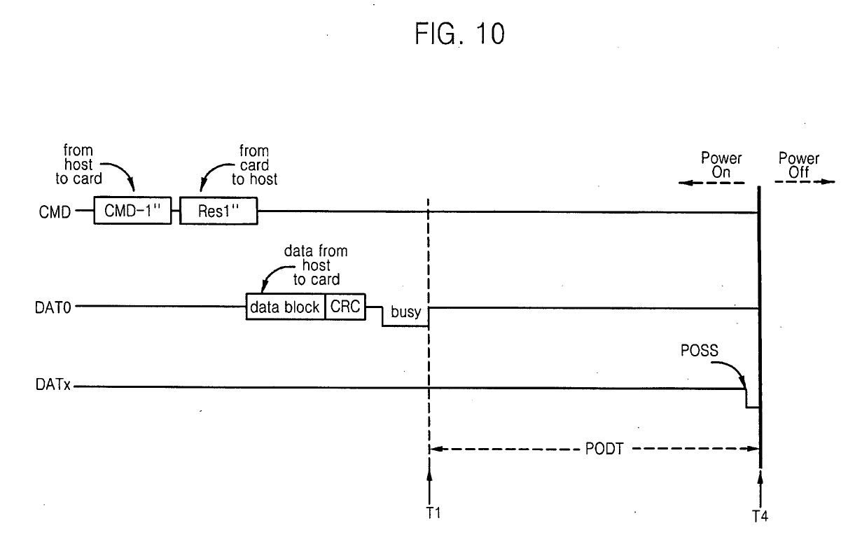

FIG. 8 is a flowchart for explaining a method for supplying power to a memory card according to another embodiment of the present invention. FIG. 9 is a third timing diagram for explaining the power supply method of FIG. 8. FIG. 10 is a fourth timing diagram for explaining the power supply method of FIG. 8.

Referring to FIGS. 2 and 8 through 10, the predetermined PODT is stored in a register (not shown) in the memory card 220 (S810). When the host 210 resets the memory card 220, the memory card 220 transmits information about the predetermined PODT to the host 210 (S820). The memory card 220 performs a write operation in response to the first write command CMD-1′ or the second write command CMD-1″ (S830). Since the completion time T1′ or T1 of the write operation performed in response to the first write command CMD-1′ or 15 the second write command CMD-1″ is described above with reference to FIGS. 4 and 5, a description thereof will be omitted.

The memory card 220 detects the completion time T1′ or T1 of the write operation (S840). For example, the memory card 220 checks the program busy signal Pbusy or the busy signal busy generated in the first data pin DAT0. In detail, the memory card 220 detects, as the complete time of the write operation, the time T1′ or T1 when the program busy signal Pbusy is in the first level state, for example, a low level state, or the busy signal busy is in the first level state is transitioned to the second level state, for example, a high level state.

The memory card 220 generates the POSS to cut off the power of the memory card 220 at the time T4′ or T4 when the predetermined PODT passes from the detected completion time T1′ or T1 of the write operation (S850). The memory card 220 transmits the generated POSS to the host 210. The host 210 cuts off the power supplied to the memory card 220 in response to the transmitted POSS.

In the power supply method shown in FIG. 5, the host 210 generates the POSS by driving any one of the data pins DATx, where x is a natural number (e.g., one of the data pins DAT1-DAT7) of the memory card 220. In contrast, in the power supply method shown in FIG. 8, the memory card 220 drives the data pin DATx, where x is 1, to generate the POSS. Thus, the memory card 220 can perform the background operation during the predetermined PODT after the write operation is complete (T1′ to T1).

The invention can also be embodied as computer readable code on a computer readable recording medium. The computer readable recording medium is any data storage device that can store data which can be thereafter read by a computer system. Also, functional programs, codes, and code segments for accomplishing the present invention can be construed by programmers skilled in the art to which the present invention pertains.

While this invention has been particularly shown and described with reference to exemplary embodiments thereof, it will be understood by those skilled in the art that various changes in form and details may be made therein without departing from the spirit and scope of the disclosure.

What is claimed is:

1. A method for supplying power to a memory card in a memory card system, the method comprising:
detecting, by a host, a completion time of a write operation of the memory card;
generating, by the host, a power off strobe signal, the power off strobe signal supplied to the memory card after a predetermined delay time passes from the complete time of the write operation; and
cutting off power, by the host, supplied to the memory card after the predetermined power off delay time passes from the time when the power off strobe signal is generated.

2. The method of claim 1, further comprising receiving information about the predetermined power off delay time from the memory card when the host initializes the memory card.

3. The method of claim 2, wherein the completion time of the write operation is detected based on a busy signal generated during the write operation.

4. The method of claim 3, wherein the generating of the power off strobe signal comprises:
maintaining a voltage level of any one of a plurality of data pins of the memory card at a first level before the predetermined delay time passes from the completion time of the write operation; and
transitioning the voltage level of the data pin to a second level after the predetermined delay time passes.

5. The method of claim 1, comprising a computer readable medium embodying instructions executable by a processor to perform the method for supplying power to the memory card.

6. A method for supplying power to a memory card in a memory card system, the method comprising:
detecting, by the memory card, a completion time of a write operation; and
generating, by the memory card, a power off strobe signal to cut off power supply to the memory card after a predetermined power off delay time passes from the completion time of the write operation.

7. The method of claim 6, further comprising:
storing the predetermined power off delay time; and
providing, by the memory card, the stored predetermined power off delay time to a host when the memory card is initialized.

8. The method of claim 7, further comprising transmitting the generated power off strobe signal to the host, wherein the host, in response to the power off strobe signal, cuts off the power supply to the memory card.

9. The method of claim 8, wherein the completion time of the write operation is detected based on a busy signal of the write operation.

10. The method of claim 6, comprising a computer readable medium embodying instructions executable by a processor to perform the method for supplying power to the memory card.

11. A memory card system comprising:
a memory card storing data; and
a host detecting a completion time of a write operation of the memory card and generating a power off strobe signal, the power off strobe signal supplied to the memory card after a predetermined delay time passes from the detected completion time of the write operation,
wherein the host cuts off power supplied to the memory card after the predetermined power off delay time passes from the time when the power off strobe signal is generated in the memory card.

12. The memory card system of claim 11, wherein the host detects the completion time of the write operation based on a busy signal of the write operation.

13. A memory card system comprising:
a memory card storing data; and
a host cutting off power supplied to the memory card in response to a power off strobe signal,
wherein the memory card detects a completion time of a write operation corresponding to a write request from the host and generates the power off strobe signal after a predetermined power off delay time passes from the detected completion time of the write operation.

14. The memory card system of claim 13, wherein the memory card detects the completion time of the write operation based on a busy signal of the write operation.
